(19) United States
(12) Patent Application Publication
(10) Pub. No.: US 2008/0245195 A1
(43) Pub. Date: Oct. 9, 2008

(54) Anti-Slip Socket Capable of Stably Applying Force in Clockwise and Counterclockwise Directions

(76) Inventor: Fang-Huang LEE, Taipei City (TW)

Correspondence Address: Dr. BANGER SHIA, 102 Lindencrest Ct., Sugar Land, TX, 77479-5201, US

(21) Appl. No.: 11/951,312

(22) Filed: Dec. 5, 2007

(30) Foreign Application Priority Data
Apr. 7, 2007 (TW) 096210914

(51) Int. Cl. B25B 13/06

(52) U.S. Cl. 81/124.6

(57) ABSTRACT

An anti-slip socket capable of stably applying force in clockwise and counterclockwise directions comprises an engaging hole having an axial rectangular engaging portion on each inner wall' central portion of at least three sides thereof, so that the respective engaging portions can be synchronously engaged with the peripheral surface of the head portion of a work piece in a surface-to-surface contact manner. Therefore, besides being applied to normally drive a work piece, the anti-slip socket is still applicable when the angles of the head portion of the work piece are deteriorated and can easily drive the head portion of the work piece no matter in the clockwise direction or the counterclockwise direction, absolutely preventing the slippage with respect to the head portion of the work piece.

### BACKGROUND OF THE INVENTION

1. Field of the Invention

The present invention relates to a socket structure, and more particularly to an anti-slip socket capable of stably applying force in clockwise and counterclockwise directions, which can drive a head portion of a work piece with deteriorated angles.

2. Description of the Prior Art

When driving a nut or a bolt head, a conventional wrench is generally engaged with a socket first, and then the socket will be engaged to the nut or the bolt head, so that the user can rotate the wrench to make the wrench drive the socket. When the socket rotates with the wrench, the socket will synchronously rotate the nut or the bolt head to perform a screwing or an unscrewing operation. It is really convenient in the operation and has fine practicality, but if the angles of the nut or the bolt head are deteriorated, a common socket becomes useless. As a result, referring to FIG. 1-2, a socket 1 was developed. The socket 1 is formed with an engaging hole 11 having inward-tapered stop ribs 12 corresponding to the central portions of the respective sides of the nut or the bolt head 2. The socket 1 is engaged with the central portions of the respective sides of the nut or bolt head 2 through the stop ribs 12, so that the nut or the bolt head 2 can be driven to rotate. It is to be noted that, since the socket 1 is only in a point-to-point contact with the nut or bolt head 2, in other words, the contact area therebetween is quite limited, there is not enough force to screw or unscrew the nut or bolt head 2. Therefore, it is frequently found that there are still a lot of nuts or bolts that cannot be rotated.

The present invention has arisen to mitigate and/or obviate the afore-described disadvantages.

### SUMMARY OF THE INVENTION

The primary objective of the present invention is to provide an anti-slip socket capable of stably applying force in clockwise and counterclockwise directions, which is still applicable when the angle of the nut or the bolt head is deteriorated besides being applied to normally drive the nut or the bolt head. With a surface-to-surface contact, the present invention can easily drive the nut or the bolt head both in the clockwise direction and in the counterclockwise direction, absolutely preventing the slippage with respect to the nut or the bolt head.

The second objective of the present invention is to provide an anti-slip socket capable of stably applying force in clockwise and counterclockwise directions. The engaging hole of the socket is designed as a hole axially tapered inward, so it has a wide application range and is applicable to different sized nuts or bolts.

Hence, the anti-slip socket capable of stably applying force in clockwise and counterclockwise directions in accordance with the present invention is disposed at one end thereof with a hexagonal engaging hole for driving a head portion of a work piece, and at the other end thereof with a connecting hole for engaging with a driving portion of a tool, and is characterized in that:

The engaging hole of the socket is formed with an axial rectangular engaging portion on the center of each of at least three inner sidewalls thereof, so that the respective rectangular engaging portions can be synchronously engaged to a peripheral surface of a work piece head in a surface-to-surface contact manner.

### BRIEF DESCRIPTION OF THE DRAWINGS

FIG. 1 is a perspective view of a conventional socket;

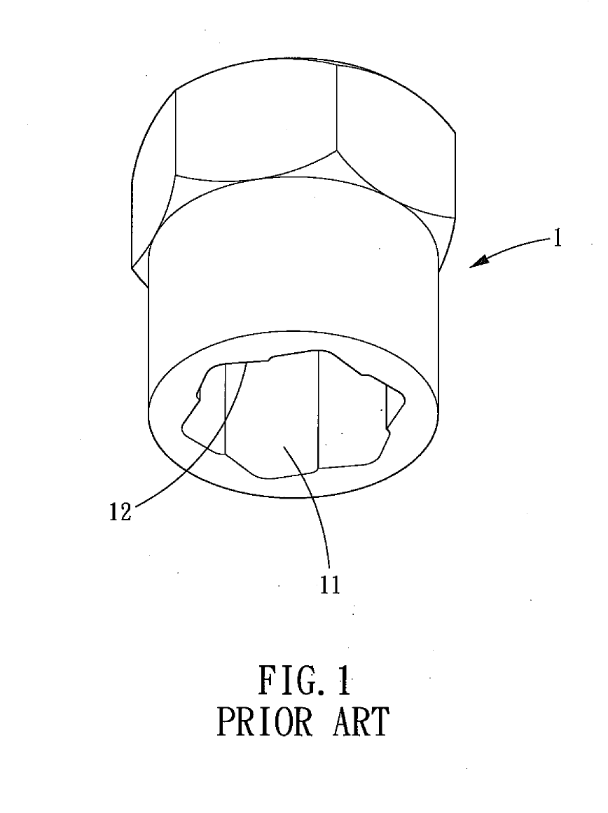

FIG. 2 is an axial cross sectional view showing how the conventional socket contacts a work piece;

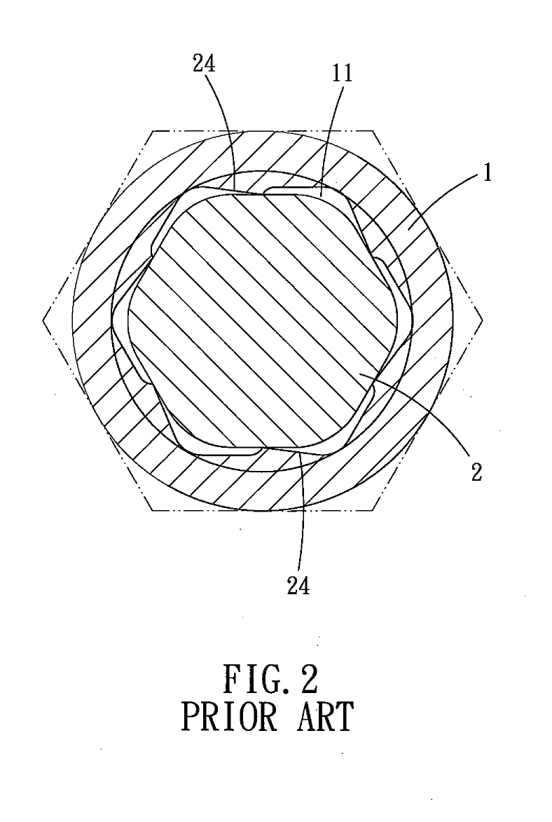

FIG. 3 is a perspective view of an anti-slip socket capable of stably applying force in clockwise and counterclockwise directions in accordance with the present invention;

FIG. 4 is an axial cross sectional view showing how the anti-slip socket capable of stably applying force in clockwise and counterclockwise directions in accordance with the present invention contacts an undamaged work piece;

FIG. 5 is an axial cross sectional view showing how the anti-slip socket capable of stably applying force in clockwise and counterclockwise directions in accordance with the present invention contacts a damaged work piece; and

FIG. 6 is an axial cross sectional view showing how another anti-slip socket capable of stably applying force in clockwise and counterclockwise directions in accordance with the present invention contacts a damaged work piece.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

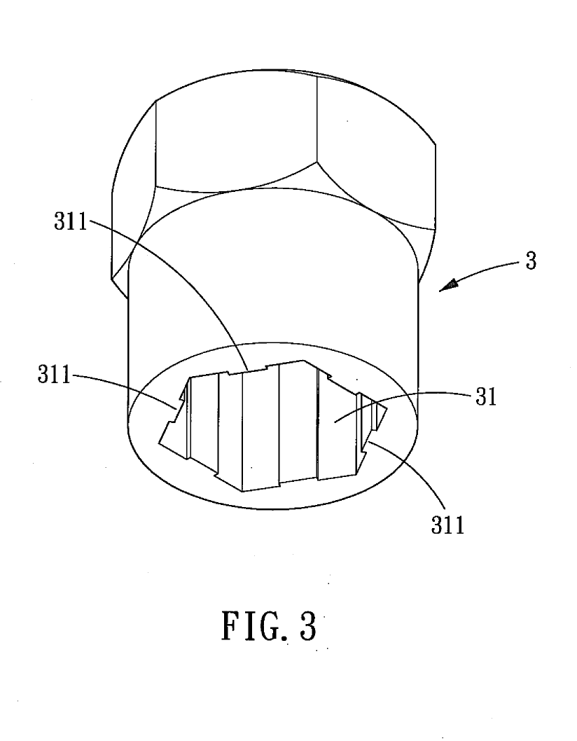

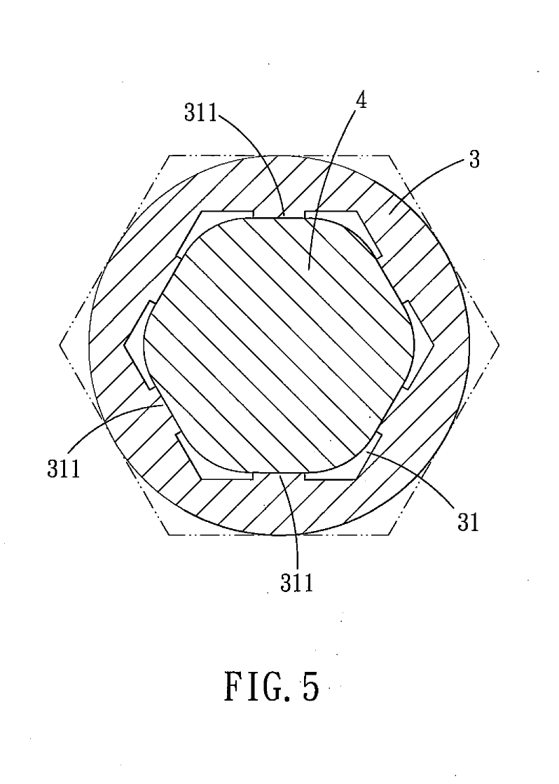

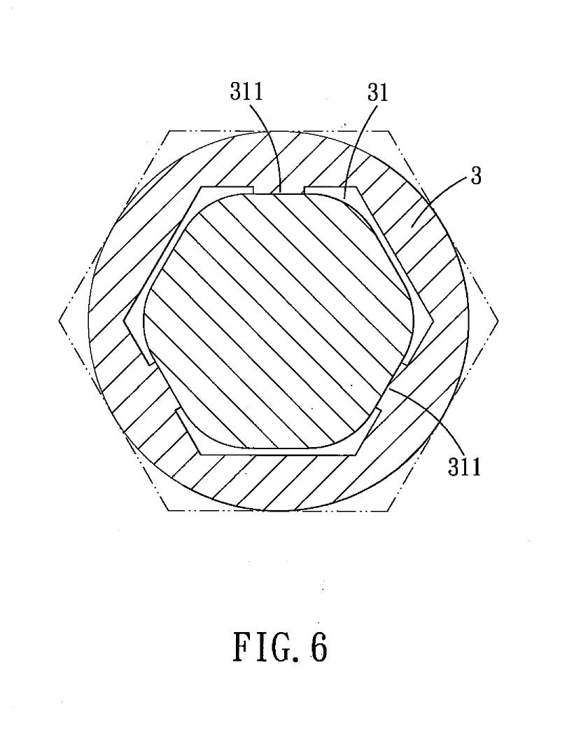

Referring to FIGS. 3-6, an anti-slip socket 3 capable of stably applying force in clockwise and counterclockwise directions in accordance with a preferred embodiment of the present invention is disposed at one end thereof with a hexagonal engaging hole 31 for driving a nut or a bolt head 4, and at the other end thereof with a connecting hole (not shown) for engaging with a driving portion of a tool. The anti-ship socket 3 of the present invention is characterized in that, the engaging hole 31 of the socket 3 is formed with an axial rectangular engaging portion 311 on the center of each of at least three inner sidewalls thereof (as shown in FIG. 6), so that the respective engaging portions 311 can be synchronously engaged to a peripheral surface of the nut or the bolt head 4 in a surface-to-surface contact manner.

It is to be noted that, in order to achieve a substantial protection, the engaging hole 31 of the socket 3 of the present invention can be formed with an axial engaging portion 311 on each of arbitrary four or five inner walls, and can also be formed with an axial rectangular engaging portion 311 on each of six inner walls thereof (as shown in FIGS. 3-5). Due to multiple rectangular engaging portions 311 contacting the nut or the bolt head, the increase of the contact area is helpful to increase the friction force therebetween, so that the nut or the bolt head is quite easier to drive.

Furthermore, in order to widen the application range, the engaging hole 31 of the socket 3 of the present invention can be formed such that it is axially tapered inward, in other words, the hole diameter close to the opening is larger while it gradually decreases inward, making the engaging hole 31 suitable for different sized nuts or bolt 4.

The aforementioned is the summary of the positional and structural relationship of the respective components of the preferred embodiment in accordance with the present invention.

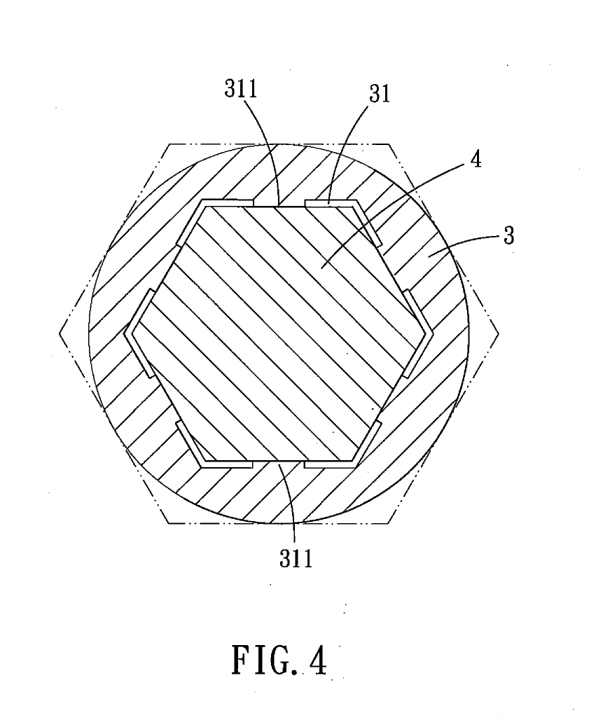

For a better understanding of the operational principle of the anti-slip socket of the present invention, reference should be made to FIGS. 3-4. The socket 3 of the present invention drives the nut or the bolt head 4 to rotate by utilizing the rectangular engaging portions 311 to contact the edges but not the angles of the nut or the bolt head 4, so no matter the nut or the bolt head 4 is fine or its angle is deteriorated, there is no influence on the contact of the rectangular portions 311 of the socket 3 and the nut or the bolt head 4, namely, the socket 3 and the nut or the bolt head 4 are always kept in a surface-to-surface contact, no matter in the clockwise direction or the counterclockwise direction, the nut or the bolt head 4 can be easily driven with the same force, absolutely preventing the slippage with respect to the nut or the bolt head 4.

To summarize, the anti-slip socket capable of stably applying force in clockwise and counterclockwise directions is still applicable when the angles of the nut or the bolt head are deteriorated besides being applied to normally drive the nut or the bolt head. With the surface-to-surface contact, the present invention can easily drive the nut or the bolt head, absolutely preventing the slippage with respect to the nut or the bolt head.

While we have shown and described various embodiments in accordance with the present invention, it is clear to those skilled in the art that further embodiments may be made without departing from the scope of the present invention.

What is claimed is:

1. An anti-slip socket capable of stably applying force in clockwise and counterclockwise directions comprising: a hexagonal engaging hole at one end thereof for diving a head portion of a work piece and a connecting hole for engaging with a driving portion of a tool, characterized in that:
the engaging hole of the socket is formed with an axial rectangular engaging portion on a center of each of at least three inner sidewalls thereof, so that the respective rectangular engaging portions are engaged with the head portion of the work piece in a surface-to-surface contact manner.

2. The anti-slip socket capable of stably applying force in clockwise and counterclockwise directions as claimed in claim 1, wherein the engaging hole of the socket is formed with an engaging portion on each of arbitrary four inner walls thereof.

3. The anti-slip socket capable of stably applying force in clockwise and counterclockwise directions as claimed in claim 1, wherein the engaging hole of the socket is formed with an axial rectangular engaging portion on each of arbitrary five inner walls thereof.

4. The anti-slip socket capable of stably applying force in clockwise and counterclockwise directions as claimed in claim 1, wherein the engaging hole of the socket is formed with an axial rectangular engaging portion on each of arbitrary six inner walls thereof.

5. The anti-slip socket capable of applying force in clockwise and counterclockwise directions as claimed in claim 1, wherein the engaging hole of the socket is axially tapered inward.
